(19) United States
(12) Patent Application Publication
(10) Pub. No.: US 2014/0074688 A1
(43) Pub. Date: Mar. 13, 2014

(54) BEHAVIORAL BASED SCORE

(71) Applicants: Simon Shvarts, San Jose, CA (US); Ilya Oskolkov, Moscow (RU); Rodion Shishkov, St. Petersburg (RU)

(72) Inventors: Simon Shvarts, San Jose, CA (US); Ilya Oskolkov, Moscow (RU); Rodion Shishkov, St. Petersburg (RU)

(73) Assignee: RAWLLIN INTERNATIONAL INC., Tortola, VI (US)

(21) Appl. No.: 13/615,053

(22) Filed: Sep. 13, 2012

(51) Int. Cl. G06Q 40/00; G06Q 40/02

(52) U.S. Cl. 705/38; 705/35

(57) ABSTRACT

A financial interaction related to a set of financial behaviors is facilitated. The financial interaction drives behaviors to affect a real-time credit risk, and the visualization of alterations (increases and decreases) of the credit risk as direct feedback. The system demonstrates how behaviors identified in the financial interaction affect credit risk. Based on the financial interaction, estimates can be made of a financial score and presented in a display.

### TECHNICAL FIELD

The subject application relates to observing behaviors and interpreting the behaviors to generate a behavioral based score.

### BACKGROUND

A number of consumers have experience with short term loans, payday advances, cash advances, and so forth. These types of financial instruments often require proof of employment and financial viability, such as a checking account and evidence of employment. Typically, the interest rate for such instruments can be high, due to the level of risk experienced by the lender. However, when a consumer needs to obtain a quick credit decision, there may be few alternatives except borrowing from pawn shops, friends, or family.

Additionally, consumers are frequently presented with opportunities to apply for instant approval for credit cards during internet shopping, or at the point of sale during traditional in-store shopping. Often the consumer can charge a current purchase to the new account if they are approved, and may be able to take advantage of one or more promotions for applying. However, consumers having little, or no, credit history are unlikely to be approved for these credit cards, such as with college students trying to start careers for the first time or groups of elderly always wary of credit. In addition, some consumers choose not to use credit cards, or elect not to go through the application process at the time that the offer is presented.

Moreover, retailers often attempt to persuade consumers to purchase additional items, or items related to items that the consumer is purchasing. In order to tailor the suggestions to the desires of the consumer, some retailers employ loyalty cards that enable the retailer to monitor the buying patterns of the consumer. Similarly, online retailers often encourage consumers to maintain a user account with the retailer, and data tracked via the user account can be used to suggest purchase options, or tailor promotions based on the consumer's buying patterns. However, similar to instant credit card applications, some consumers choose not to go through the loyalty card application or online account setup process.

The above-described deficiencies of today's credit application and promotional tools lend for the need to better serve and target potential clients. The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for facilitating a financial interaction and determining a financial score from a set of behaviors related to the financial interaction are contained herein. An exemplary system comprises a memory that stores computer-executable components, and a processor, communicatively coupled to the memory, that facilitates execution of the computer-executable components. An advice component is configured to generate a set of recommendations related to improving a financial score according to a set of financial behaviors. A behavioral analysis component is configured to generate an analysis of a financial interaction to determine a set of indications of the set of financial behaviors, based on a set of behavioral criteria. A scoring component is configured to generate a financial score based on the set of indications of the set of financial behaviors corresponding to the set of recommendations.

In another non-limiting embodiment, a method comprises generating, by a system including at least one processor, a set of recommendations related to improving a financial score according to a set of financial behaviors. The method includes determining, from a financial interaction, a set of indications related to the set of financial behaviors, based on a set of behavioral criteria, and generating a financial score based on the set of indications of the set of financial behaviors corresponding to the set of recommendations.

In still another non-limiting embodiment, an exemplary computer readable storage medium has computer executable instructions that, in response to execution by a computing system that causes the computing system to perform operations. The operations can comprise generating a set of recommendations related to a set of financial behaviors. At least one indication is received from a financial interaction stored on a client device of a financial behavior of the set of financial behaviors, and a financial score is computed based on the at least one indication received

In another non-limiting embodiment, a system is disclosed comprising means for generating a set of recommendations related to a set of financial behaviors; means for determining a financial score based on at least one behavior that is determined to be related to the set of recommendations; and means for adjusting the financial score based on different indications received related to the set of recommendations.

The following description and the annexed drawings set forth in detail certain illustrative aspects of the disclosed subject matter. These aspects are indicative, however, of but a few of the various ways in which the principles of the various innovations may be employed. The disclosed subject matter is intended to include all such aspects and their equivalents. Other advantages and distinctive features of the disclosed subject matter will become apparent from the following detailed description of the various innovations when considered in conjunction with the drawings.

### BRIEF DESCRIPTION OF DRAWINGS

FIG. 1 illustrates an example system in accordance with various aspects described herein;

FIG. 2 illustrates another example system in accordance with various aspects described herein;

FIG. 3 illustrates another example system in accordance with various aspects described herein;

FIG. 4 illustrates an example index component in accordance with various aspects described herein;

FIG. 5 illustrates an example feedback component in accordance with various aspects described herein;

FIG. 6 illustrates an example presentation component in accordance with various aspects described herein;

FIG. 7 illustrates a flow diagram showing an exemplary non-limiting implementation for a system in accordance with various aspects described herein;

FIG. 8 illustrates a flow diagram showing an exemplary non-limiting implementation for a system in accordance with various aspects described herein;

FIG. 9 is a block diagram representing exemplary non-limiting networked environments in which various non-limiting embodiments described herein can be implemented; and

FIG. 10 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. In addition, the term “set” refers to “one or more.”

In consideration of the above-described deficiencies among other things, various embodiments are provided that dynamically interpret data related to clients for credit worthiness, and, more generally, is related to generating advice, guidelines and/or recommendations related to financial behavior that involves facilitating and observing a set of financial interactions, such as financial transactions, financial settings, financial savings, and/or any interaction that is financially related. Additionally, an interaction or a financial behavior that includes an interaction can be related to a client or consumer's habits, spending patterns, style of living, etc. For example, information can be obtained about the consumer patterns and life styles not only from his ledgers, but also from various other sources, including, but not limited to lifestyle data, a consumer/client profile, implicit questionnaires, analysis of consumer social network profiles, and other public online related data, such as an RSS feeds the client is subscribing to and TV shows he is watching online or online window shopping patterns or recent visits.

The advice can be provided in the form of dialogues, conversations, and/or, in other words, exchanges based on a user's behavior to determine a set of recommendations to alter the set of financial behaviors. The set of financial behaviors can include a person's risk tolerance level, spending habits, goal setting, saving habits, payment history, financial attitudes towards each, and/or other behavioral indications (e.g., indicators) that relate to financial behaviors, financial habits, financial beliefs, and/or financial attitudes that relate to the set of recommendations.

In one example, a financial interaction is generated in response to the actual financial behavior (recent transactions, savings, debits and credits, rent, etc.) of a user. A financial interaction is facilitated according to the transactional behavior and recommendations provided to the user, whose behavior is tracked via communications with a transactional database or system component (e.g., a digital wallet, bank account aggregators, etc.) in order to determine whether the user implements the set of recommendations and/or to what degree the user implements the set of recommendations. In one example, the recommendation system can recommend reducing spending in a particular category, and a financial score is determined based on how the user behaves in response to the recommendation, such as how well the user accepts and follows the set of recommendations.

To determine the credit worthiness of a client for a small loan, a large loan or some other financial instrument, information pertaining to the client's behavior is obtained by facilitating a financial interaction, such as an exchange, a dialogue, and/or a conversation with recommendations and determinations as to how the user acts upon the recommendations. A set of behaviors can include, for example, beliefs, actions related to various stimuli (e.g., better credit offers, improved credit rating options, savings tips, etc.), inputs and/or responses. The set of behaviors can be ascertained from indicators (indications) that are identified throughout a financial interaction with a client. These indicators can be used to determine a set of financial scores that are displayed from, during and/or throughout the interaction. The indicators can be utilized as a factor or as a basis to determine a credit worthiness score for the client interacting in the financial interaction.

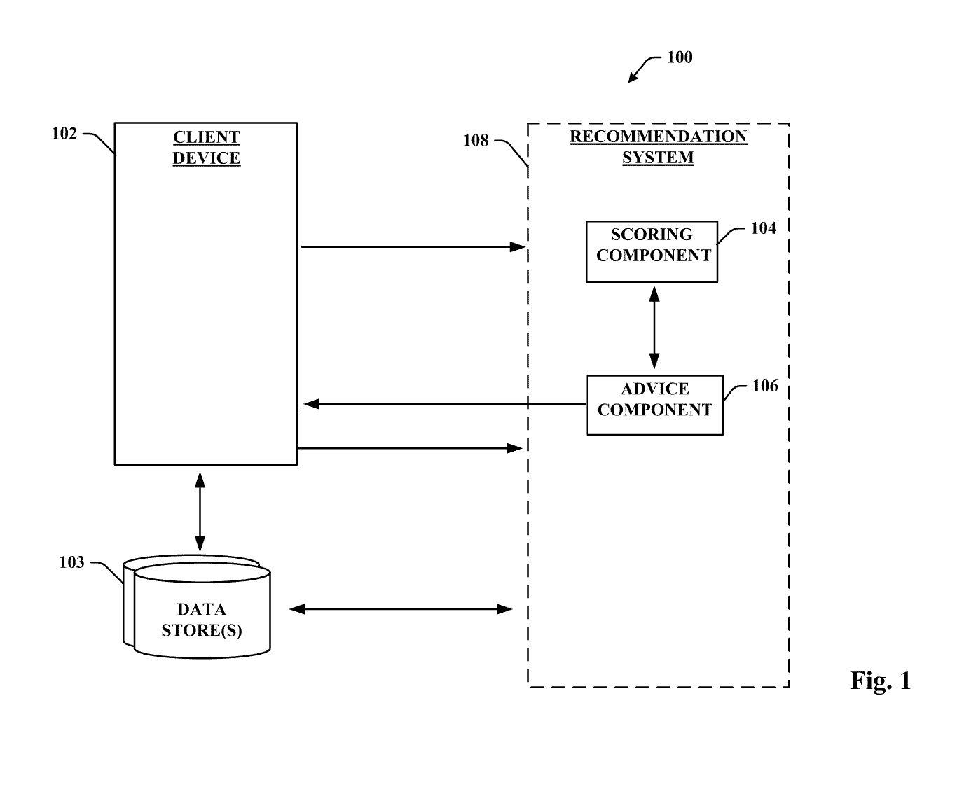

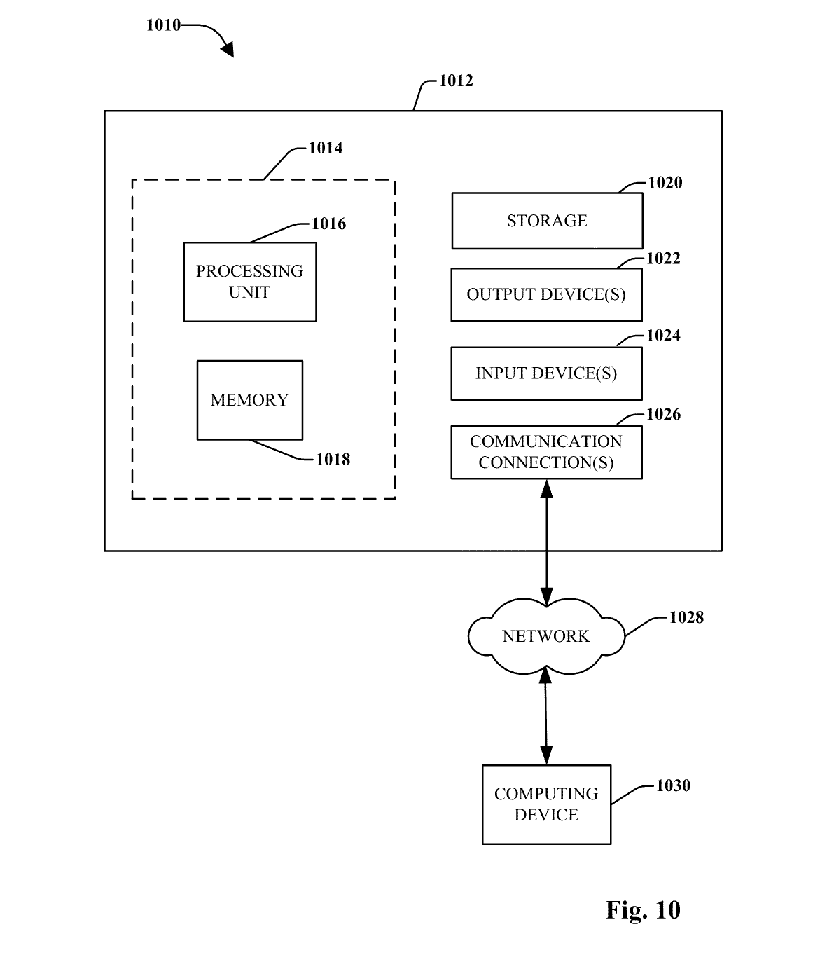

Referring initially to FIG. 1, illustrated is an example system 100 to output one or more recommendations pertaining to potential clients in accordance with various aspects described herein. The system 100 is operable as a recommendation system and includes the recommendation system 108 that is configured to recommend ways to increase a financial or credit score, improve financial behavior that is related to, for example, financial goals, spending behavior, financial condition, investment recommendations, savings, credit, payment, etc., to recommend credit to potential clients, and/or to provide recommendations such as marketing strategies based on the set of behaviors (e.g., set of beliefs, habits, tendencies, characteristics indicating behaviors, etc.) observed and/or based on an analysis of a dynamically and iteratively generated set of behaviors demonstrated during (from) financial interactions (e.g., transactions, a set of exchanges, and/or other such interactions related to a set of financial behaviors by a user or client of the system). Embodiments disclosed herein can, for example, identify slowly evolving problems, enable more efficient maintenance scheduling, identify devices that require special attention or a change in operation role, identify related performance issues, and so forth. System 100 can include a memory that stores computer executable components and a processor that executes computer executable components stored in the memory, examples of which can be found with reference to FIG. 10. It is to be appreciated that the computer 1012 can be used in connection with implementing one or more of the systems or components shown and described in connection with FIG. 1 and other figures disclosed herein.

The system 100 includes a client device 102 that includes a computing device, a mobile device and/or a mobile phone as well as a digital wallet, a bank account aggregator and the like that is operable to communicate one or more messages via an electronic digital message (e.g., a text message, a multimedia text message, and the like) and/or with an audio input via a microphone, for example. The client device 102 can include a processor and at least one data store that processes and stores exchanges of a financial interaction (e.g., a set of conversations, exchanges, and/or interactions). The client device 102 is operable to communicate, exchange and/or interact with one or more data stores 103, which represent any other data source from a system or device that operates to provide behavioral monitoring/analytical data about the client or client device, such as a transactional system (e.g., a bank), geo-location (e.g., Telco), and/or any other similar data source. A financial interaction, as used herein, can include a number of responses or behaviors of the client that can be generated and/or tracked from among one or more devices (e.g., client device 102), and/or one or more data stores (e.g., data store(s) 103). For example, a set of recommendations or a suggestions can be provided to a client that can include a set of questions, a set of answers, a set of statements, a set of declarations, a set of data, etc., that are exchanged during a dialogue interaction, and based on indications of the user's behavior in response to the recommendations by the user, the system 100 operates to determine and/or update a financial score.

The system 100 operates to provide a set of advice, guidelines or recommendations to a user such as with or to a client device, for example from an advice component 106. The recommendations can be in response to the behavior ascertained or monitored from the client device 102. In one such implementation, the recommendation system 108 determines a set of financial behaviors from the client device 102, a data store (not shown) and/or other means in order to provide a set of recommendations. Based on the set of recommendations provided to the user by the advice component 106, the recommendation system 108 determines a user behavior from one or more indications of a financial interaction (e.g., a transaction, exchange, and/or following act) that are related to the recommendations provided. Based on the indications of how well the user's behavior corresponds to the set of recommendations, a financial score is computed with the scoring component 104. For example, a financial score is initially calculated based on the client behaviors ascertained, and additionally re-calculated after the advice is provided for adjusting, modifying or encouraging further behavior, such as a set of financial behaviors (e.g., transactions, payment plans, re-financing, etc.). The financial score can then be further communicated to the user via the client device 102 as well as additional advice for further improvement and/or other financial information.

The recommendations system 108 processes and analyzes complex relations with a client. For example, a financial score is determined based on how a user responds to recommendations by the system 108 as well as financial behavior determined. The recommendation system 108 therefore generates a proactive analysis of user behavior (i.e., user makes own decision), which is assessed by the system, such as whether a client has a high interest rate on a credit card, mortgage rates, financial bank terms, and/or any financially related aspect of the user. In response to the analysis, the recommendation system 108 sends suggestion via the advice component 106, for example, to refinance with a different credit card or loan for better terms. Whether the user follows, follows to some degree (a different option) or does not follow the suggestion at all, the recommendation system 108 assesses user behavior over time. In cases where a user did not followed or did follow a recommendation from the advice component 106, but initiated a better term card on his or her own cognizance, such as by refinancing the card, the recommendations system 108 is still operable to continue to analyze the behavior and monitor how the behavior impacts the user's financial condition and compute a financial score. The scoring component 104 is configured to base the computation of the user's financial score based on the user's behavior. The financial score can be computed also according to recommendations and/or degrees of correlation to the set of recommendations and the financial behavior monitored. After the advice is provided, the system continues to monitor behavior and continue the process of scoring the behavior, providing advice, determining the behavior, further calculating or re-calculating the financial score, providing advice and continuing to determine financial behaviors. Further embodiments described below provide further examples and details to the recommendation system 108.

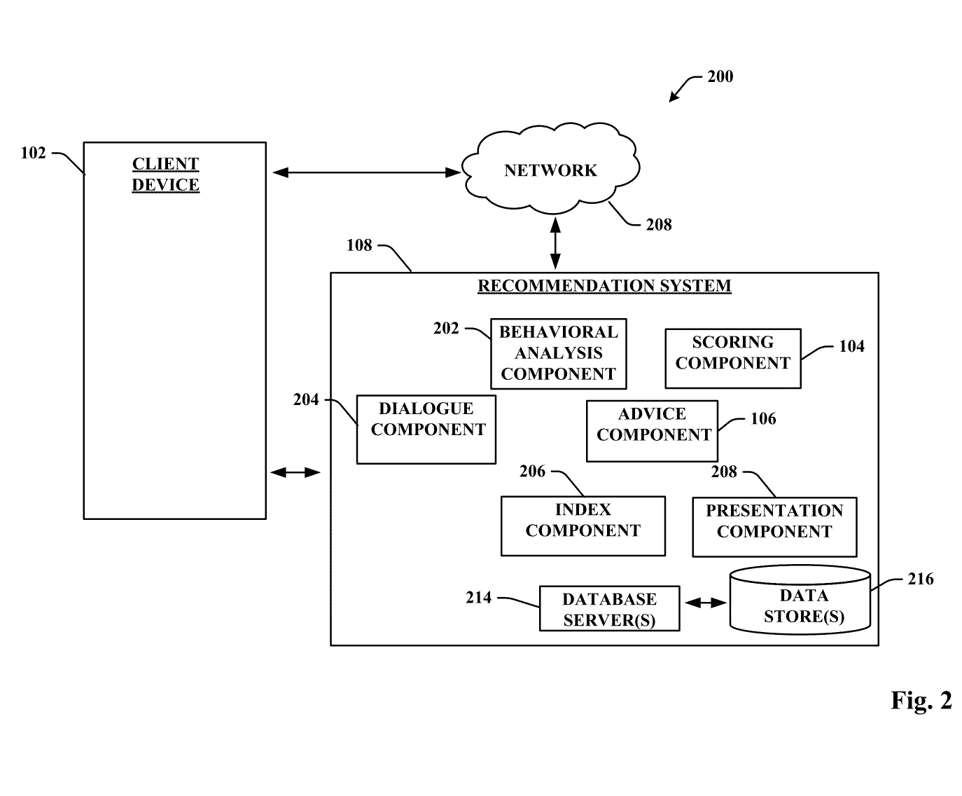

Referring now to FIG. 2, illustrated is an example system 200 to output one or more recommendations pertaining to users or clients and generate a financial score based on responsive behavior in accordance with various aspects described herein. The client device 102 is operable to communicate media content via the network 208, which can include a cellular network, a wide area network, local area network, and/or other type network. The network 208 can also include a cloud network that enables the delivery of computing and/or storage capacity as a service to a community of end-recipients that entrusts services with a user's data, software and computation over a network. Additionally, the client device 102 can include multiple client devices, in which end users access cloud-based applications through a web browser, a light-weight desktop or mobile app and to resources of the recommendation system 108.

The system 200 includes the recommendation system 108 that is communicatively connected to one or more servers and/or client devices via the network 108 for receiving user input and communicating during the financial interaction. The network 208 is communicatively connected to the recommendation system 108, which is operable as a networked host to provide, generate and/or enable message generation on the network 208 and/or the client device 102 either directly or via the network 208. The recommendation system 108 can include an application programming interface (API) server, in which the client device 102 and/or other client device, for example, can requests various system functions by calling one or more APIs for invoking a particular set of rules (code) and specifications that various computer programs interpret to communicate with each other. For example, interaction with a client or customer can be facilitated via a behavioral analysis component 202, a dialogue component 2, and the scoring component 104104, as well as with other various components, in which each have applications for hardware and/or software.

The recommendation system 108 further includes a database server/processor 214 that is operatively coupled to one or more data stores 216, which includes data related to various described components and systems described herein, such as questions, scenarios, recommendations, a set of indicators that can be indexed, stored and classified to correspond with a set of text inputs, as well as other data for determining a financial scores via a financial interaction. Aspects of the systems, apparatuses or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), electronic devices, virtual machine(s), etc. can cause the machine(s) to perform the operations described.

The recommendation system 108, including the dialogue component 204, the behavioral analysis component 202 and the scoring component 104, is configured to facilitate, analyze and generate feedback such as financial advice, recommendations and/or guidelines during a financial interaction with a client or the client device 104. The dialogue component 204 is configured, for example, to facilitate dialogue or conversation, such as a financial interaction to the client device 102. The dialogue component 204 is operable to generate or receive conversation with the client and is communicatively coupled with the advice component 106 to generate feedback in the form of advice or other feedback with the recommendations or advice to the user.

The financial interaction is based on a set of financial behaviors, such as a behavioral interaction based on whether the client or user follows advice or recommendations that are provided by the advice component 106. For example, the recommendation system 108 via the advice component 106 and/or dialogue component 204 generates a set of recommendations or suggestions, which is related to the financial behaviors of the user.

In one embodiment, the dialogue generated by the dialogue component 204 can be between the recommendation system and the client device 102, in which live interaction can occur between at least one user and with the dialogue component 204. The dialogue component 204 can facilitate dialogue through various means, such as via live interaction among two parties, a voice generated interaction, key pad interaction, chat interaction and/or interaction with various forms, questionnaires, responses, recommendations, etc., in which advice or suggestions provided to the client are then tracked, such as via a digital wallet, bank account aggregators, and other such information sources of financial data related to the client's behavior.

In one example, a client can indicate by dialogue “I am planning to go on vacation, it is better if I plan it in advance and start setting money aside, and, here is my plan.” In return, advice component 106 can generate a set of preventative recommendations that operate on a future behavior indication compared to an observed past behavior that generates an advice, such as “don't take that loan for holidays, take this”. Positive reaction to both recommendations is improvement to the financial score, while one, such as the former, can be weighted to produce a higher grade for the user accordingly.

In one example, a user interacts with the recommendation system 108 via the client device 102 through a discussion at a web portal, website, chat room, etc., which is operated by the dialogue component 204. The advice component 106 and the dialogue component 204 can dynamically respond to actual financial behavior, such as recent transactions, savings, debits and credits, rent payments and any other such financial related behavior associated with the client via the client device 102. The responses from the advice component 104 can be recommendations or advice that includes options for improving the client's financial condition, while the dialogue component 204 can follow up with additional information or related financial information to aid, further educate, and/or obtain from a user or the client device 102. For example, a question could be provided by the dialogue component 204 that is a closed ended question (e.g., eliciting yes or no answers), such as “Would you like to receive a lower interest rate on a credit card, or register for auto-pay for one or more bills?” Other types of questions or options could also be provided to provide a set of financial recommendations and to indicate a user's behavior in response to the recommendations in conjunction with the advice component 104.

Based on how the user follows a recommendation, suggestion and/or, otherwise, and advice, the system 100 is configured to determine a financial score. In addition, the advice component 104 can provide options or recommendations in response to questions, such as open or closed ended questions, scenario options, data fields, etc., to further facilitate an interaction about a client's finances for determining indicators to the client's behavior. For example, a question such as “Would the client like to provide savings in a savings account?”, “From what account would the client like to transfer money to a savings account?”, “What frequency would the client like to transfer money to a savings account?” and other such financially related questions or options could be generated by the dialogue component 204. Because behaviors, such as a client's financial behavior, can be a product of various beliefs, habits, and experiences, as well as abilities and means, the system gauges these sets of behaviors from indicators (or indications) of the client's behavior. Once indicators are determined about a client's financial behavior, recommendations or advice can be further given for further modifying the behavior, and a financial score can be determined in response to the user's actions in relation to and how correlated the actions are to the recommendations generated by the advice component 106.

In one embodiment, a financial score is presented to the client device from various indications or indicators that are determined from the client device 102 (e.g., a digital wallet, bank account aggregator and/or the like). The recommendation system 108 is configured to receive a set of inputs based on the financial interactions, in which the set inputs can include key indications of whether or how the client has behaved according to various behavioral criteria, such as following the advice, and/or in what ways the client has followed the advice or not. The inputs or interactions can be further analyzed to ascertain a measured financial score, such as a financial score for the user to view dynamically.

The behavioral analysis component 202 is configured to analyze the data obtained from the client device 102 and/or some other device, component or system (e.g., a digital wallet, bank account aggregators, and the like) during or from the user's behavior in a financial interaction (e.g., following the advice in a transaction, exchange, conversation, application, etc.) that is facilitated by the recommendation system 108. The behavioral analysis component 202 is configured to identify and/or determine indicators that are related to the client's financial behavior from information retrieved about the client's behavior (e.g., from the client device, a data store, a third party server, and/or other source). The indicators can be a set of behavioral indicators related to the client's financial behavior in a financial interaction that occurs after the advice is provided by the advice component 106, for example. The indicators are used to make an assessment or objective measure of the client's behavior. The indicators can thus provide evidence that the client has, has not or in what manner the client has acted with the set of behaviors for sound or healthy finances in accord with the advice or recommendations provided. For example, the set of behaviors can include any action that would improve the client's financial score in accord with the recommendations for the client to have sound or healthy financial behavior. The indicators can therefore be negative, positive, or neutral, and can be used to provide a financial score or to measure the client's credit worthiness based on the financial score. For example, if the recommendation system 108 can assess the behavioral responses provided by the client device 102 for competence to “make payments well,” “to save” etc., the behavioral analysis component 202 compares responses received from the client device 102 to an index of possible positive or negative indicators for competency in making payments well, saving, utilizing a better currency rate, a better interest rate, a better bank rate and the like, for example. In other embodiments, indications of competencies can be a competence to “accelerate paying loans off”, “reduce interest rates”, “freeing more spendable cash due to restructuring outstanding debts”, “allocating more cash towards savings”, “setting and following financial plans”. While on-time payments may not be recommend directly, unless late payments are due to negative cash flow, then the system can recommend a plan to improving the predicament. Subsequently, if a client is to follow through with the recommendations successfully, system could improve the user's financial score.

In another embodiment, the system is operable to quantify and qualify a result of following or not following the recommendation by establishing an algorithm (set of processes) for a ratio of dependencies between monthly, pay-cheque to pay-cheque, quarterly, and or annually income and debt and or expense. For example, the advice or recommendations could be to “follow this suggestion to increase ratio to 5-3 from current 5-1”. If end result by the user produces 5-4—above the suggested then a financial score can equal AA+, or other numerical, alphabetic or alphanumeric score. For example, a 5-2 is better than it was, but not as good as suggested so the financial score could equal BB.

An example of positive behavioral indicators can be that the client makes payment obligations each month, pays obligations on time, does not get behind on payments, pays bills immediately, pays entire balance to avoid interest each month, has a predetermined number of bills that are paid (e.g., at least four, and under ten bills), as well as other such financial indications or indicators of various financial conditions that are related to the behavioral criteria of the recommendations, suggestions and/or advice given to the client via the advice component 106.

Negative indicators that can be related to a competency for “making payment well” that are analyzed by the behavioral analysis component 202 could be the opposite of the positive indicators, and also include other indicators such as having too many or too few bills to pay. Making a minimum payment only could be a neutral indicator that could elicit a recommendation to double payments with a calculated amount of interest that would be saved to the client device 102. The system can also, for example, make a suggestion to “pay mortgage bi-weekly to pay loan off ten years early”. No one indicator or set of indicators are fixed, and any number of indicators related to financial conditions or states of behavior are envisioned to be utilized by the recommendation system 108.

In another example, the behavioral analysis component 202 can measure competencies for saving, with indicators such as having a savings account, a percentage of savings established, and/or a desire to save as indicated by answers to questions involving open ended, closed ended and/or scenario questions, and/or as indicated by tracking of a digital wallet, a bank aggregator or some other financial transaction system that can track the user's financial behavior. Various indicators can be useful to indicate a client's behavior since a person could say one thing, but behave differently, especially when a delayed gratification response is low. Scenario questions could be dynamically generated to include certain things a person likes, such as video games, cars, food, etc., which could be presented to the client as part of a financial scenario with choices to purchase one of these likes that are new and available as opposed to more frugal options, such as increasing savings or saving for education, in which a dialogue with the dialogue component could in addition be used for computing the financial score.

Various competencies can be analyzed during a financial interaction with the client device 102 and can further include a financial score that is updated dynamically or in real time during the financial interaction as different indicators of the client's behavior toward finances are analyzed. The analysis of the indicators can be based on a set of behavioral criteria, such as aspects of various competencies as discussed above. The behavioral criteria can include a matching of the indicators to a score in an index stored in a data store (e.g., data store 216) that corresponds to predefined financial conditions, such as having a savings account, desire to open a savings account, desire and ability to save, choosing to save over choosing to spend on a desired item when confronted with different financial scenarios (not paying bills, paying for education, etc.).

In addition, the behavioral criteria can include a matching of the set of financial behaviors of the client with the recommendations provided and/or a degree of correlation ascertained by the indications received. Indicators for each of these criteria can be first elicited through the facilitated financial interaction in the form of recommendations, suggestions or advices that can also include questions, open ended or closed ended questions, scenarios, and/or statements that can be rated on a predefined scale according to how the client follows the advice or what options the client follows or behaves according to. For example, the behavioral analysis component 202 can detect that the user exchanges currency while traveling and detects that the conversion rate was not good. The dialogue component 204 can then recommend to the user to exchange his currency at a different place. If indications are detected that the user ignored the advice, the system 100 can then downgrade the user's score. The system can thus punish the user for not thoroughly research the alternative (depending on exchange amount). If the amount was $10, then this could be negligible to the system. For $1000, the system could expect the shopper to prepare better in advance and have studied the options.

In another example, the behavioral analysis component 202 can detect that the user did not pay his credit card balance in full and thus will need to pay a higher interest rate. The system 100 via the dialogue component 204 can inform the client (e.g., the client device 102) and ask the client if he wants to be reminded next time, as well as provide further options such as setting up auto-pay and/or other financial recommendations. According, to the client's behavior a financial score is upgraded or downgrades. For example, if the client follows the advice, his score can be upgraded based on how the client responds and/or to what advice the client follows or does not follow. The system is thus operable to analyze and assess user behavior independent from the recommendations provided as well as based thereupon. For example, a client went ahead and purchased a TV, which was paid for by in-store high interest consumer loan. Such act may be deemed as negative and reduce user score for erratic and unplanned behavior.

Each indicator provided by the client and ascertained by the behavioral analysis component 202 can be looked up in an index and matched for a score. The scoring component 104 is configured to generate a financial score based on the set of indicators of financial behavior, such as did the client follow a recommendation or not, or follow some other course of action that demonstrates sound or healthy financial responsibility. The financial score for example can be a combination of scores that correspond to one or more indicators. For example, the scores can be summed together and weighted based on other indicators and/or based on the number of other categories of indicators that have been determined. Throughout the financial interaction, as more indicators for various types of financial related behaviors/competencies are determined, the score can be altered and dynamically generated by the scoring component. Thus, the client device 102 is able to view or receive a financial score throughout the financial interaction to show how behavior and/or behavior changes influence financial health.

In one embodiment, the financial scores can be determined from a combination of predefined scores matching different financial conditions, which can be already weighted. For example, rating a behavior that indicates a low belief in saving money can be set to indicate a low financial score and then be used to determine the degree of correlation that the user's behavior is to the set of recommendations provided by the advice component 106. The financial score can be based on a scale that can be similar to the scale for a credit score or can be based on a different range of numbers, which can have various ranges therein corresponding to excellent, good, mediocre, bad and/or terrible financial behavior. The scoring component 104 is operable to determine and provide to the client device 102 a score based on one indicator and an updated score based on other indicators that are determined throughout the financial interaction.

In one embodiment, the recommendation system 108 is operable to interpolate the financial score where an indicator is provided of financial condition and there is no matching score within an index for a particular indicator. For example, where a client provides input indicating a desire to save, but the client provides a mixed answer where either conflicting indicators are provided or there is no score indexed to the indicator, then the financial score can be interpolated. For example, the scoring component 104 can use a different formula where a response in the financial interaction has too many indictors, conflicting indicators, and/or indicators not matching an indexed score. Rather than adding scores, or sampling matching indexed scores, the scoring component 104 can define a financial score based on the nearest indexed score in the index within a predetermined distance. For example, if a strong desire to save is indicated, but a lack of an ability to save is determined from the responses or behaviors detected, a score could interpolate the strength of the ability as being between the scores for a strong desire and a mediocre desire. Other methods of interpolation can also be used to determine indications of behavior that are not indexed with a matching score such as piecewise constant interpolation, linear interpolation, polynomial interpolation, and other forms of interpolation. This further enables a more dynamic analysis and keeps financial scores related to as many responses as possible during the financial interaction.

In another embodiment, the recommendation system 108 is operable to generate multiple financial interactions with a client device 102. In some cases, for example, the client device 102 can undergo various financial interactions in order to increase their score or obtain a target score for credit worthiness. In this manner, the financial interactions generated by the dialogue component 204, can operate as tutorials by which a client is able to learn better behaviors that can generate better scores. A user can undergo this process different ways such as by trial and error, a reverse mapping scheme, a chronology of financial scores mapped to a time line of the financial interaction, and/or through other like methods. A reverse mapping, for example, can provide an illustration of sample responses or behaviors within the financial interaction that could generate a target score that the user desires to obtain. For example, where the user answered or behaved in one way, other ways of answering various questions or behaving could be sampled to illustrate how to obtain a better score. While multiple different behaviors, questions, responses and/or answers could be used to calculate a financial score during the course of a financial interaction by the scoring component 104, the reverse mapping could provide various samples of behaviors or answers that could generate a better score or a target score inputted via the client device 102.

In another embodiment, the recommendation system 108 is operable to generate a chronology of the financial scores that are updated or altered throughout the financial interaction with the user. For example, answers, responses, and/or exchanges generated throughout the financial interaction can be mapped along a time line with corresponding financial scores that are generated in responses to indicators identified. In this manner, the user can see how certain behaviors affect financial health. Where certain areas of the dialogue are based on certain competencies or certain behaviors, the user can see where weaknesses and/or strengths could be.

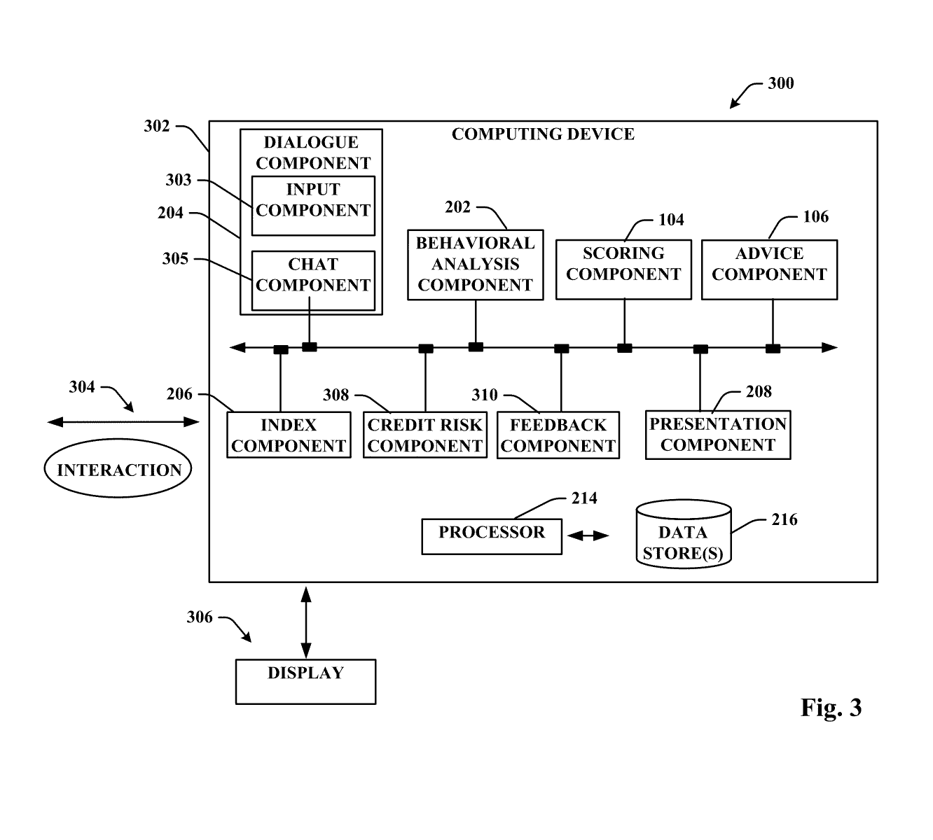

Referring now to FIG. 3, illustrated is a system 200 that facilitates a financial interaction and generates a financial score based on the facilitated financial behavior in accordance with various embodiments. The system includes a recommendation system 108 with similar components as in FIG. 2 above. The recommendation system 108 includes an input component 303 and a chat component 305, in which the dialogue component 204 includes as example architecture, but other configurations are also envisioned. The recommendation system 108 further includes an index component 206 and a presentation component 208.

The input component 303, for example, is configured to receive a set of inputs based on the financial interaction, the set of inputs including at least one of a voice input, a text input, or a selection input received during the financial interaction that is analyzed for media content to correspond with certain indicators, such as actions, words or phrases related to a set of behaviors. The input component 303 can include one or more mechanisms in addition to a touch panel that permit a user to input information thereto, such as microphone, keypad, control buttons, a keyboard, a gesture-based device, an optical character recognition (OCR) based mechanism, a joystick, a virtual keyboard, a speech-to-text engine, a mouse, a pen, and/or voice recognition and the like. The client (or user) can input selections or options to follow according to the recommendations provided, such as to set up a savings account, auto pay, and/or other financial options that are presented to the client device 102.

A chat component 305 is configured to transmit and receive at least one of textual dialogue, voice dialogue, video content or image content related to the financial interaction. For example, a user can view various selections, questions, statements, options, scenarios of financial situations, conditions and the like, chat with a live representative, view recommendations or financial advice tips during the interactive financial dialogue generated. The chat component 305 can generate a chat screen in order to facilitate various stimuli in the form of questions and answers sessions that facilitate interaction and enable the recommendation system 108 to ascertain indicators regarding the user's behavior, which includes the beliefs, knowledge, experiences that form the behavior in the user. The chat component 305 can generate a chat session that responds dynamically to a user with artificial intelligence logic, such as rule based logic, fuzzy logic and/or other artificial intelligence design. For example, a user can respond with concerns about saving money, and the system could focus questions, scenarios, and the like to generate indicators in order to measure or rate the behavior and how a credit score would correspond. The credit score, for example, can be determined by the scoring component 104 and be predefined based on the indicators matching conditions in an index with a score. The index scores can be predefined based on real life data from people having similar scores with similar behaviors (i.e., behavioral characteristics) related to financial behavior, or analyzed based on another rating which weights various indicators based on desired behavior and the level in which the behavior is encouraged or discouraged, for example.

The index component 206, for example, is configured to index the set of indicators and a set of index scores related to the set of indicators analyzed during the financial interaction. The indicators, for example, can be indexed as a set of financial conditions such as saving for an emergency, paying bills on auto pay, paying bills on time, budgeting and/or other financial behaviors, whether positive, negative and/or neutral. These financial conditions and behaviors are related to financial health and can be categorized and/or indexed with a score or weight factor to be used in calculating a financial score. As positive indicators of behavior are determined in the client responses to the recommendations during the interactive dialogue, the score is increased according to the amount of positive impact to a client's credit that the behavior can have, and similarly, decreased with predefined negative indicators. Examples of negative indicators are financing a car without a job, financing a car without any savings, opening a line of credit at a retail store without savings or with multiple other lines of credit, having carried over balances without paying the balance in full, borrowing money on any line of credit without making other payment obligations (e.g., monthly minimum payment, late fees, etc.), and/or other conditions negatively impacting a short term and/or long term financial condition. The behavioral analysis component 202 determines the key identifiers related to various financial conditions from the information provided by the client device 102, a digital wallet, bank account aggregator, and or other such devices that indicate a financial behavior or a financial condition. The index component 206 indexes key identifiers that matching various financial conditions, and via a presentation component 208 the client device 102 can dynamically view financial scores during the course of the financial interaction as various key identifiers are determined and scored by the scoring component 104.

The presentation component 208 is configured to facilitate display of the financial score and alter the displayed financial score during the financial interaction based on a change in the set of indicators and updated scoring of the scoring component 104. For example, the presentation component 208 is configured to display the financial score including a plurality of financial indicators that include at least one of a financial credit score number or a financial credit grade. A number of scoring indications are envisioned, such as a letter grade, a number (e.g., a credit risk number with the highest number being about 850 and the lowest being about 300, and/or any other number range), as well as quality indications that can be illustrated according to colors (e.g., red different shades to black).

The presentation component 208 is further configured to display a chronology of the plurality of financial/indicators that are calculated during the financial interaction. For example, a series of behaviors over time, which can be in connection with recommendations, suggestions or advice form questions, scenarios and/or statements can be generated to dialogue with the client device 102. In addition, each interaction in the series can be generated with time lines along with the financial scores at each of the time lines. As scores are altered, and/or updated, the presentation component 208 displays or communicates to the client device 102 the updated or altered score. Therefore, the presentation component 208 is operable to generate a dynamic presentation of financial scores to a user during the financial interaction.

Referring now to FIG. 3, illustrated is a system 300 that facilitates a financial interaction with a user and determines a financial score based on a set of financial behaviors from the financial interaction in accordance with various aspects described herein. The system 300 includes similar components as discussed above. The system 300 includes a computing device 302 that can include a mobile device, such as a mobile phone and/or any other computing device. The computing device 302 includes the dialogue component 204, the behavioral analysis component 202, the scoring component 104, the processor 214, the data store 216, the index component 206, and the presentation component 208. The computing device 302 further includes a credit risk component 308 and a feedback component 310.

The computing device 302 is operable to receive inputs during and from a conversation, exchange and/or a financial interaction 304 related to a set of financial behaviors. The financial interaction 304 can be a transaction, exchanged involving a set of financial behaviors and/or conversation that is carried out live via text, instant messaging, voice over telephone, and the like, in which the voice input from a client on a client device (e.g., mobile device, phone, computing device, etc.) is converted to words and/or phrases in text by the dialogue component 204 and/or analyzed for indicators of behavior by the behavioral analysis component 202. Additionally or alternatively, the interaction 304 between client device and the computing device 302 can be via a text exchange, instant messaging exchange, or any conversational dialogue that includes data being exchanged, in which a second data is in response to a first data and so on. The financial interaction 304 is a dynamic interaction that can be continuous during a user session comprising a plurality responses and exchanges with the computing device 302, which is operationally similar to the recommendation system 108 discussed above, but can include a mobile phone, a computing device, a mobile device, a handheld device and the like device operable to interact directly with the client rather than via a different client device. The financial interaction 304 can be facilitated by the dialogue component 204, as discussed above, to drive and continue conversation, exchange, or, in other words, dialogue regarding a set of financial behaviors, such as behavior in accordance with recommendations or not. The dialogue component 204 can alter conversational exchange towards a user interest in order to drive conversation towards areas of concern, or where improvement in a financial condition could be. For example, advice about home ownership could get a response about savings, in which the dialogue component 204 can begin exchanges about savings by questioning the user if he or she would like to interact about savings first or another topic for evaluating a financial score.

The set of financial behaviors can include any number of financial conditions of actual behaviors within a financial interaction (e.g., utilizing a financial application to apply for a loan, etc., a transaction involving auto-pay sign-up, exchanging a high rate card for a lower rated card, etc.) as well as dialogue, in which a client can provide response to and/or about via an answer, a closed ended statement (yes, no), a declarative statement of fact and the like. The index component 206 indexes various financial conditions based on indicators, which can be behaviors including words, phrases in audio and/or text that include a statement or indication of a belief or tendency to adhere to at least one financial condition indexed as well as tracked or detected behaviors as to whether recommendations were followed. The words and/or phrases are evaluated by the behavioral analysis component 202 for indicators of financial conditions, which can be indexed by the index component 206. The words and/or phrases, for example, can be in response to or selections to follow or not the recommendations provided to the user. In situations where statements, words and/or phrases, are not pre-indexed, but are deemed related to a financial behavior, by a statement, words or phrases, a closest approximate evaluation is performed by the behavioral analysis component 202 and the index component 206 such as by an interpolation. In addition, the index component 206 can learn conditions or indicators to index via a learning component. Scores can be interpolated, then later adjusted and stored based on an external assessment of the financial interaction or session.

The computing device 302 via the scoring component 104 generates a display 306 of the various topics discussed during the financial interactions, as well as an ongoing financial score that gets updated, altered or modified during the financial interaction based on the set of behaviors determined during the course of the interaction. For example, the behavioral analysis component 202 determines indicators, such as detected behaviors, words or phrases that indicate a behavior to a recommendation as provided via the dialogue component 204. The indicators determined provide indications of the set of beliefs related to the financial interactions 304. The indictors are used to determine a score, such as a financial score during the financial interaction 304, which is dynamically displayed throughout the interaction in the display 306 for a user to observe. The display 306 can be a touch screen display for selections to be received via a touch, and/or any type of display communicatively coupled to the computing device 302 or to an external device that is in communication with the computing device 302.

The computing device 302 includes the credit risk component 308 that is configured to determine a correlation between the set of indicators and a plurality of financial behaviors external to the facilitated financial interaction, and to determine a set of credit worthiness indicators based on the correlation. For example, the set of credit worthiness indicators include at least one of an interest rate or a credit worthiness score, such as a credit rating or credit risk indication. In other words, the amount of correlation (e.g., a correlation degree) between the financial scores determined from the financial interactions and actual behaviors determined from actual credit data, payments history, credit history, etc., for example, is factored into determining a credit worthiness score for giving a loan recommendation or other financial instrument. Various data sources, including the data store 216 and other internal and external data stores, can be employed for determining the credit worthiness, such as credit reports, or agencies/bureaus with private data pertaining to the client's credit score rating (e.g., TransUnion, Equifax, and Experion). Information about the client is searched with key search words (e.g., name, data of birth, email addresses, and the like). The data is collected and stored in a profile, such as a profile memory (not shown). The profiles of each client contain client characteristic data that includes information collected over the any number of data bases. The credit risk component 308 is operable to determine a credit worthiness score based on external data in combination with the financial score determined from the set of financial interactions analyzed by the computer device, or, in other words, the recommendation system 108 discussed herein.

The feedback component 310 of the computer device 302 is configured to generate advice content related to behavioral responses received or detected during the financial interaction based on the set of indicators. For example, advice on spending with different consequences that affect the financial score from the scoring component 104 can be provided by the feedback component 310 in response to input received during the financial interaction 304. For example, a conversation or a portion of the financial interaction 304 could include the subject of savings, and based on the responses received, the feedback component 310 generates a list of ways to save that can be elaborated on according to further inputs received. A question could be provided, for example, whether the client believes saving is a top priority or goal, and a “yes” answer to setting up a savings account or other type savings account could incrementally raise the financial score of the client as dynamically displayed in the display 306. In response to the yes, the computing device 302 could inquire further into what the client would like to save for. If the answer is beer this weekend, or some other short term benefit, a decrement to the user's score could be attributed to the score as a result of the behavior of uncontrolled delayed gratification associated with finances. A more long term savings plan would hint towards a more long term thinking client, which would be better prepared to invest money with, such as for a loan or the like. A series or set of behaviors determined provide a more accurate financial score.

Additionally, the feedback component 310 is configured to generate warnings that a certain type of move could detrimentally affect the financial score, in response to the score being lowered by a response that is a predefined difference. For example, in response to the client indicating that he or she would like to mortgage their home under an 80/20 loan/principal ratio, the system could generate that this would drop their financial score from 600 to 500, or some other difference in a range of scores.

An advantage of assessing financial risk or recommendation for credit on publicly available data is providing wider latitude to consumers needing such instruments. In particular, small business loans can be based on factors that do not require strict criteria, but can be assessed more heavily based on a person's behavior and behavioral modifications, which is ascertained from financial interactions with the customer.

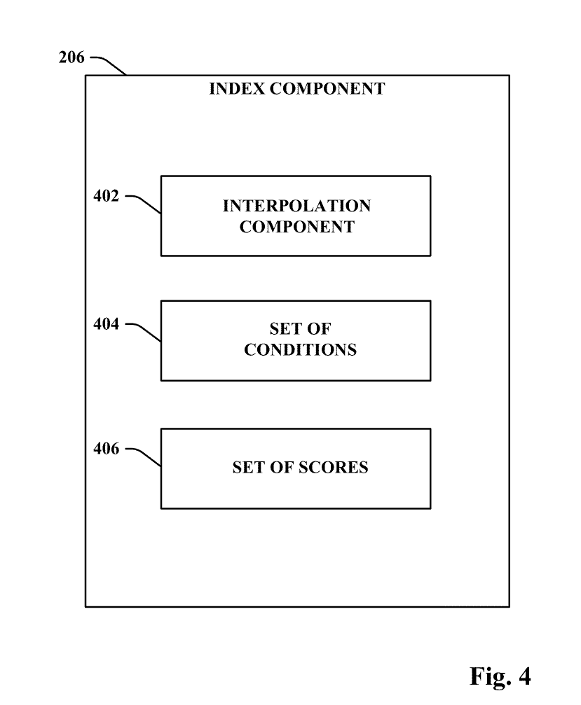

Referring now to FIG. 4, illustrates an exemplary index component 206 in accordance with various embodiments described herein. The index component 206 is configured to index various financial conditions 404 based on indicators, which can be transactional events, time stamped exchanges, exchanges for altering a credit card rate, or any financially related exchanged set of actions including words, phrases in audio and/or text that include a statement or indication of a belief or tendency to adhere to at least one financial behavior based on a condition (e.g., a situation presented, and/or other financial condition) for the set of recommendations. Based on input received from the behavioral analysis component 202, the index component 206 evaluates the set of conditions indexed for a match or closest match, and then, compares the condition to a set of scores 406, which is then outputted to the scoring component, for example, for computation of the financial score based on the set of behaviors corresponding to the set of recommendations, or, in other words, the amount in which the set of behaviors correspond to the set of recommendations provided to the client/user or client device.

The indexing component 206 is operable to learn various financial conditions based on different financial interactions with other clients and/or with the same client. In situations where behaviors are not pre-indexed, but are deemed related to a financial behavior a closest approximate evaluation is performed by the behavioral analysis component 202.

The index component 206 can categorize and index new financial conditions, and during an interactive session or interaction involving a set of behaviors to determine a score based on an interpolation made by the interpolation component 402. For example, where saving for education may be a good condition that provides an increment of ten to fifteen points to the financial score, saving for a movie could be something that is not indexed, but given a score of close to ten since saving is a positive behavioral financial condition, although it is not a long term item. Therefore, an interpolated score could be determined by the interpolation component 402 based on something in between saving and not saving at all, or saving and saving for education, which is a more long term thought process requiring greater discipline than simply saving for anything.

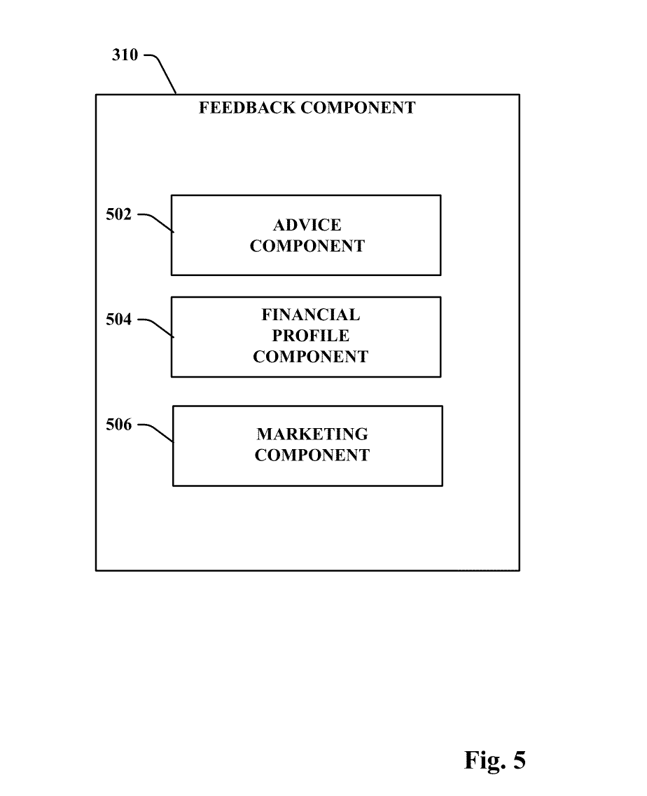

Referring now to FIG. 5, illustrated is a feedback component 310 in accordance with various embodiments described herein. The feedback component 310 includes an advice component 502, a chronology component 504, a financial profile component 506, and a marketing component 508.

The advice component 502 communicates further advice related to the behavior determined during the financial interactions. For example, various warnings, tips, hints, suggestions and/or recommendations can be generated to a user based on behavioral responses received. The financial profile component 504 is operable to generate a profile related to a certain client from the financial interaction and store the data profile in a data store 216, for example. The financial profile component 504 is configured to retrieve a set of search results from data sources in response to a search query, which can be a credit score, a credit history, such as a credit report from a public or private data base as well as from the client device 102. The financial profile component 504 is configured to generate the client profile with metadata (e.g., attributes or characteristics) associated with the client and to rank the metadata according to a level of validity and/or relevance to the client. Characteristics or attributes are assimilated as metadata associated with the client profile in storage, for example, and can be from data sources that can include virtually any open source or publicly available sources of information, as well as private sources, including, but not limited to websites, search engine results, social networking websites, online resume databases, job boards, government records, online groups, payment processing services, online subscriptions, and so forth. In addition, the data sources can include private databases, such as credit reports, loan applications, and so forth.

In one embodiment, the credit risk component 308 communicates with the financial profile component 504 to obtain information that is external to the financial interaction and to evaluate a correlation degree between the information on behavior obtained during the interaction and the profile information from the financial profile component 504. Based on the correlation, the credit risk component can calculate a credit worthiness score.

The advice component 502 and the financial profile component 504 are communicatively coupled to a marketing component 506. Based on predetermined criteria such as information obtained from official data sources and information obtained from publicly available data sources, the marketing component 506 can output recommendations for providing credit, a loan or other financial instrument to a client, such as via a marketing plan or strategy. For example, where a life experience can make one marketing strategy for a loan discouraging to a client, another strategy could be used to portray financial instruments in a better light. Rather than only basing recommendations on financial data, the marketing component 506 determines recommendation on publicly available data such as the interest, abilities, skills, temperament, associations and character aspects of the client, for example.

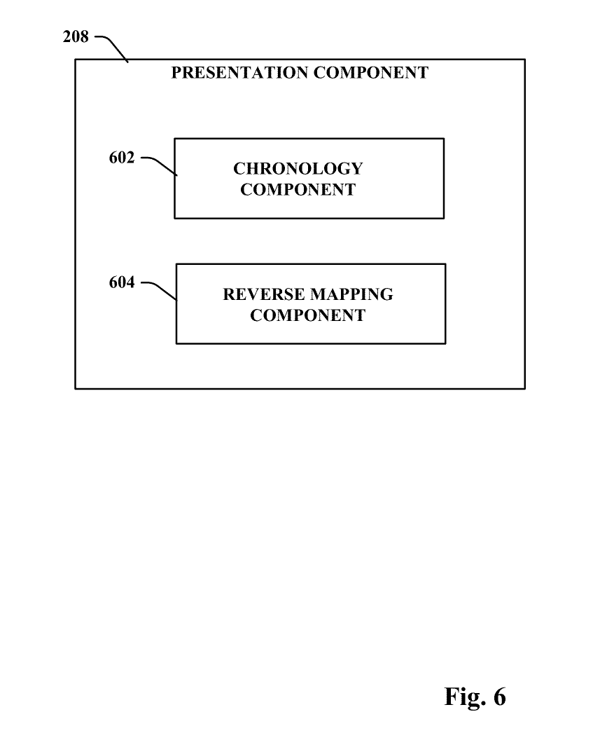

Referring now to FIG. 6, illustrated is an exemplary presentation component 208 in accordance with various embodiments described herein. The presentation component 208 is configured to present, generate or display a financial score during the financial interaction and dynamically display the financial score as it alters or is modified during the course of the financial interaction (e.g., a continuous conversation or dialogue exchange). The presentation component 208 includes a chronology component 602 that generates a chronology of the plurality of financial/indicators (indications) that are determined during the financial interaction. The chronology can, for example, be along a time line having time stamps where each indicator is determined, or any time interval. In addition or alternatively, the indicators can be presented with the financial scores along the sequence of responses so that a user can see how particular interactions or responses can affect the financial score. For example, a series of questions, scenarios and/or statements can be generated to dialogue with a client and each interaction in the series can be time stamped and illustrated along time lines along with financial scores related to each exchange or response received by the client. As scores are altered, and/or updated, the presentation component 208 displays or communicates to the client device 102 the updated or altered score. The chronology component 602 can dynamically generate the time line or chronology with the financial scores during the financial interaction.

The reverse mapping component 604 can generate a reverse order or a reverse mapping of the financial interaction in order to demonstrate to a client how the client could obtain a target score, which could be different from the actual financial score determined from the interaction. In this manner, the financial interactions can even be scenarios or interactions generated by the dialogue component 204, which, in one embodiment, can operate as tutorials by which a client is able to learn better behaviors that can generate better scores. A user can undergo this process different ways such as by trial and error, a reverse mapping scheme, a chronology of financial scores mapped to a time line of the financial interaction, and/or through other like methods. The reverse mapping component 604 is configured to generate the reverse mapping, for example, that provides an illustration of sample responses within the financial interaction could generate a target score that the user desires to obtain. The reverse mapping component 604 receives a target score and based on the financial interaction, or an upcoming future financial interaction with the user is configured to generate set of responses that would enable a better score. For example, where the user answered one way, other ways of answering various questions could be sampled to illustrate how to obtain a better score, which can be mapped in a reverse hierarchy of the financial interaction. While multiple different questions, responses and/or answers could be used to calculate a financial score during the course of a financial interaction by the scoring component 104, the reverse mapping could provide various samples or answers that could generate a better score or a target score inputted via the client.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

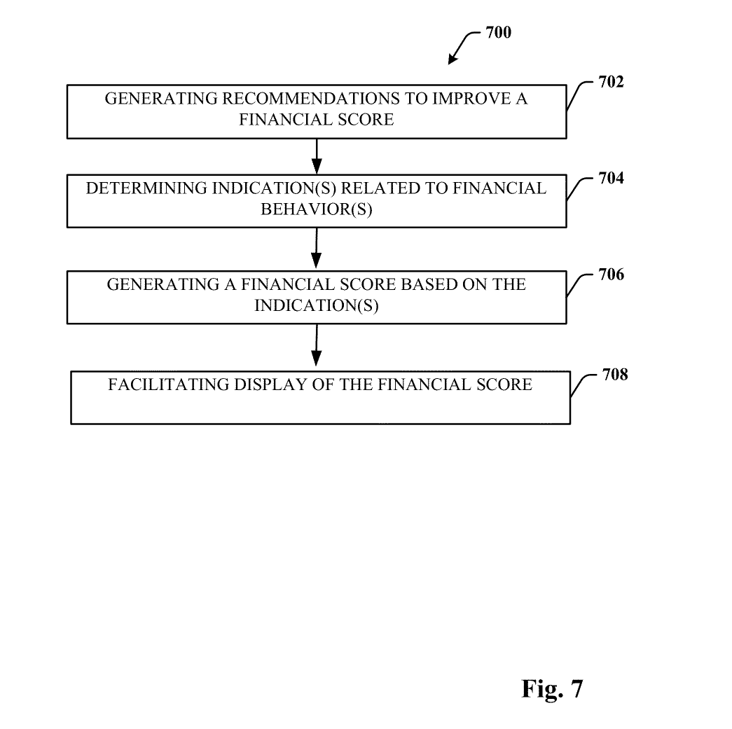

An example methodology 700 for implementing a method for a system is illustrated in FIG. 7. Reference is made to the figures described above for ease of description. However, the method 700 is not limited to any particular embodiment or example provided within this disclosure.

FIG. 7 illustrates the exemplary method 700 for a system in accordance with aspects described herein. The method 700, for example, provides for a system to interpret a financial interaction to determine one or more financial scores from the interaction based on a set of financial advice or recommendations. At 702, a set of recommendations is generated to improve a financial score. A financial interaction can also be facilitated that relates to a set of financial behaviors (e.g., beliefs, habits, knowledge, characteristics to personality, etc.). A series of questions, data, scenarios, and/or statements, for example, could be provided to initiate and continue conversation along a client financial behavior and/or attitude. For example, a dialogue can include a continuous interaction along a series of questions and answers that includes responses, advice and guidance for financial improvement.

At 704, a set of indicators (indications) are determined related to the set of financial behaviors according to a set of behavioral criteria (e.g., a level of matching of the behaviors to the recommendations, a degree of the matching, and/or an interpolation of the behavior in relation to the recommendations). The indicators, for example, can be key words or phrases, recorded transactions, stored exchanges, applications for better rates, initiating better rates, etc., that are identified or determined through a client device or other source from financial interactions. The determining can be based on a set of behavioral criteria that, for example, includes a matching of financial conditions having scores that are weighted or predefined with the indicator. For example, the indicators can correspond with a set of conditions that are indexed, such as actions, statements or words pertaining to financial categories, situations, topics, and/or other conditions related to financial behavior.

At 706, a financial score is generated that is based on the set of indicators. For example, certain indicators can be indexed or tied to a positive score that increments a client's score, while other indicators could be more negative and cause a decrement to the financial score.

At 708, a display of the financial score is facilitated. The displaying can be dynamically during the financial interaction and updated dynamically throughout the course of the interaction.

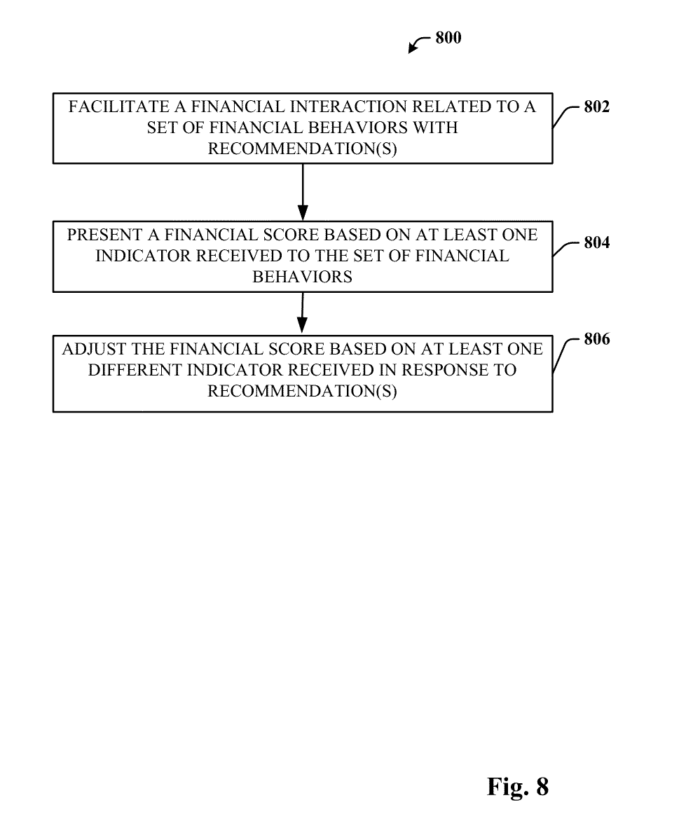

An example methodology 800 for implementing a method for a system in accordance with various embodiments herein is illustrated in FIG. 8. Reference may be made to the figures described above for ease of description. However, the method 800 is not limited to any particular embodiment or example provided within this disclosure.

The method 800, for example, provides for a system to facilitate a dialogue with a client and generate financial score(s) during the dialogue. At 802, a financial interaction related to a set of financial behaviors with a set of financial recommendations is facilitated. At 804, a financial score is presented based on at least one indication/indicator received to the set of financial communications or exchanges that occur during the financial interaction. At 806, the financial score is adjusted based on at least one different indication/indicator received in response to the recommendations.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

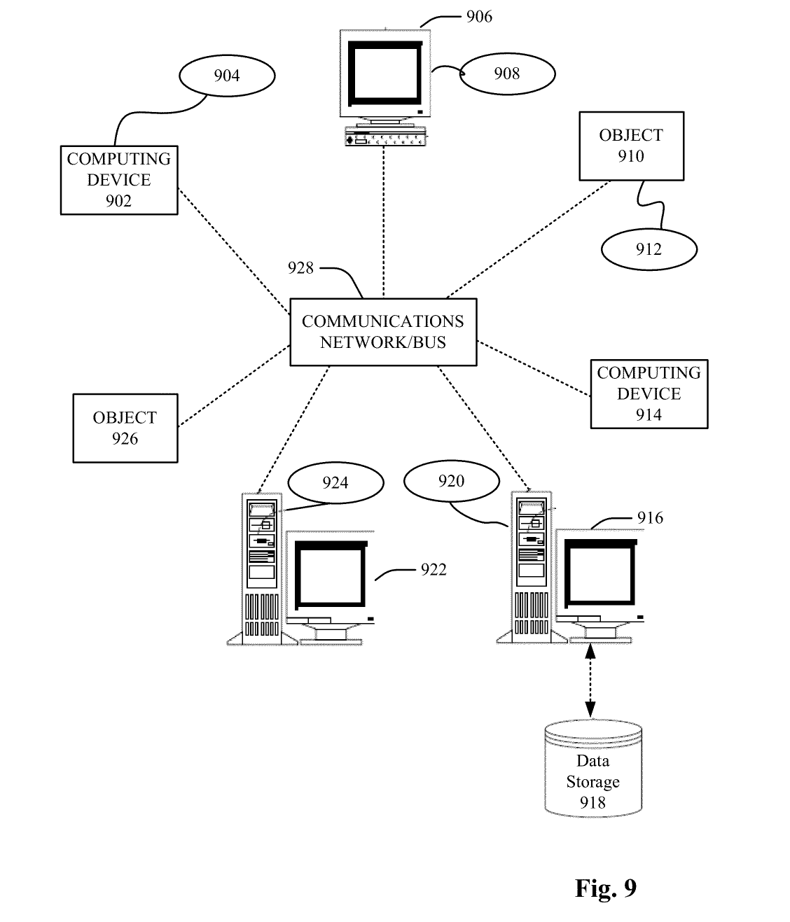

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects 910, 912, etc. and computing objects or devices 920, 922, 924, 926, 928, etc. may comprise different devices, such as personal digital assistants (PDAs), audio/video devices, mobile phones, MP3 players, personal computers, laptops, etc.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 940, either directly or indirectly. Even though illustrated as a single element in FIG. 9, communications network 940 may comprise other computing objects and computing devices that provide services to the system of FIG. 9, and/or may represent multiple interconnected networks, which are not shown. Each computing object 910, 912, etc. or computing object or device 920, 922, 924, 926, 928, etc. can also contain an application, such as applications 930, 932, 934, 936, 938, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc., acting as servers provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 940 or bus is the Internet, for example, the computing objects 910, 912, etc. can be Web servers with which other computing objects or devices 920, 922, 924, 926, 928, etc. communicate via any of a number of known protocols, such as the hypertext transfer protocol (HTTP). Computing objects 910, 912, etc. acting as servers may also serve as clients, e.g., computing objects or devices 920, 922, 924, 926, 928, etc., as may be characteristic of a distributed computing environment.

### Exemplary Computing Device

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 12 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 10 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1010.

Device 1012 may also include communication connection(s) 1026 that allows device 1010 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1018 and storage 1020 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1010. Any such computer readable storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system, comprising:
a memory that stores computer-executable components; and
a processor, communicatively coupled to the memory, that facilitates execution of the computer-executable components, the computer-executable components including:
an advice component configured to generate a set of recommendations related to improving a financial score according to a set of financial behaviors;
a behavioral analysis component configured to generate an analysis of a financial interaction to determine a set of indications of the set of financial behaviors, based on a set of behavioral criteria; and
a scoring component configured to generate a financial score based on the set of indications of the set of financial behaviors corresponding to the set of recommendations.

2. The system of claim 1, wherein the computer-executable components further comprise:
a presentation component configured to facilitate display of the financial score and alter the displayed financial score from the financial interaction based on a change in the set of indications.

3. The system of claim 1, wherein the set of behavioral criteria include a criterion of whether the set of indications match at least one of the set of recommendations or a set of index scores in an index corresponding to a set of predefined financial conditions.

4. The system of claim 1, wherein the computer-executable components further comprise:
an input component configured to receive a set of inputs based on the financial interaction, the set of inputs including at least one of a voice input, a text input, a selection input received during the financial interaction or a tracked financial behavior of the set of financial behaviors.

5. The system of claim 1, wherein the financial interaction includes a set of financial behavioral options including at least one of a suggested financial option, data gathering options or a communication based on an updated financial condition.

6. The system of claim 5, wherein the financial interaction includes receipt of the set of financial behaviors based on the set of financial behavioral options that are tracked by the behavioral analysis component.

7. The system of claim 6, wherein the set of behavioral criteria include whether the set of financial behaviors occur according to the set of financial behavioral options.

8. The system of claim 1, wherein the computer-executable components further comprise:
a chat component configured to transmit and receive at least one of textual dialogue, voice dialogue, video content or image content related to the financial interaction.

9. The system of claim 1, wherein the computer-executable components further comprise:
an index component configured to index the set of indications and a set of index scores related to the set of indications from the financial interaction.

10. The system of claim 9, wherein the set of index scores includes a set of weights that correspond to input received during the financial interaction, and the financial score includes a combination of the set of index scores based on the set of weights.

11. The system of claim 1, wherein the scoring component includes an interpolation component configured to interpolate a set of index scores in an index corresponding to a set of predefined financial conditions in response to an analyzed input being related to at least one of the set of indications and not matching at least one of the set of index scores.

12. The system of claim 11, wherein the interpolation component is further configured to interpolate the set of index scores of the index within a predetermined distance from the at least one of the indications matching the at least one of the set of index scores.

13. The system of claim 1, wherein the financial interaction includes multiple interactions related to the set of financial behaviors including reception of first data in response to a set of financial behavioral options being communicated via a client device including a digital wallet.

14. The system of claim 1, wherein the set of indications comprise words, phrases, or selections that indicate a financial behavior of the set of financial behaviors or a financial condition.

15. The system of claim 14, wherein the behavioral score changes in response to the set of indications being received, wherein the financial interaction includes a communication of an updated financial condition, related to the set of financial behaviors.

16. The system of claim 1, wherein the scoring component is further configured to alter the financial score during the financial interaction based on a change in the set of indications analyzed from input to the financial interaction.

17. The system of claim 1, wherein the computer-executable components further comprise:
a feedback component configured to generate advice content based on responses or indicators obtained from the financial interaction.

18. The system of claim 1, wherein the computer-executable components further comprise:
a presentation component configured to display the financial score that includes at least one of a financial credit score number or a financial credit grade.

19. The system of claim 18, wherein the presentation component is configured to display a chronology of the plurality of financial indicators that are calculated from the financial interaction.

20. The system of claim 18, wherein the computer-executable components further comprise:
a credit risk component configured to determine a correlation between the set of indications and a plurality of financial behaviors external to the facilitated financial interaction, and to determine a set of credit worthiness indicators based on the correlation.

21. The system of claim 18, wherein the set of credit worthiness indicators include at least one of an interest rate or a credit worthiness score.

22. A method, comprising:
generating, by a system including at least one processor, a set of recommendations related to improving a financial score according to a set of financial behaviors;
determining, from a financial interaction, a set of indications related to the set of financial behaviors, based on a set of behavioral criteria; and
generating a financial score based on the set of indications of the set of financial behaviors corresponding to the set of recommendations.

23. The method of claim 22, further comprising:
altering the displayed financial score from the financial interaction based on a change in the set of indications.

24. The method of claim 22, further comprising:
receiving a set of inputs based on the financial interaction, the set of inputs including at least one of a voice input, a text input, a selection input or a tracked financial behaviour of the set of financial behaviors that comprise responses to the financial interaction.

25. The method of claim 22, further comprising:
indexing a set of index scores that correspond to various financial conditions with the set of indications.

26. The method of claim 22, wherein generating the set of recommendations related to improving a financial score according to a set of financial behaviors comprises: communicating at least one of a set of financial behavioral options including at least one of a suggested financial option, data gathering options, or a communication based on an updated financial condition.

27. The method of claim 22, further comprising:
generating an advice based on responses or indications obtained from the financial interaction.

28. The method of claim 22, further comprising:
presenting a chronology of financial scores determined from a plurality of financial interactions and the indications that factor into determining financial scores of the chronology of financial scores.

29. The method of claim 22, further comprising:
determining a correlation degree between the determined indications from the financial interaction and the set of financial behaviors that correspond to the set of recommendations.

30. The method of claim 29, further comprising:
determining a set of credit worthiness indicators based on the correlation degree, wherein the set of credit worthiness indicators include at least on of an interest rate or a credit worthiness score.

31. A computer readable storage medium comprising computer executable instructions that, in response to execution, cause a computing system to perform operations, comprising:
generating a set of recommendations related to a set of financial behaviors;
receiving at least one indication from a financial interaction stored on a client device of a financial behavior of the set of financial behaviors ; and
computing a financial score based on the at least one indication received.

32. The computer readable storage medium of claim 31, wherein the set of recommendations are generated in response to the set of financial behaviors determined and the financial score is computed based on the at least one indication received related to the set of financial behaviors after generating the set of recommendations, wherein the set of financial behaviors includes at least one of a financial goal, a spending behavior, a loan request, or a saving behavior.

33. The computer readable storage medium of claim 31, the operations further comprising:
determining whether the at least one indication satisfies a set of behavioral criteria including at least one of a criterion of whether the at least one indication matches a set of index scores in an index corresponding to a set of predefined financial conditions or at least one of the set of recommendations.

34. The computer readable storage medium of claim 33, the operations further comprising:
indexing a set of index scores that correspond to various financial conditions with the set of indications.

35. The computer readable storage medium of claim 31, the operations further comprising:
determining a correlation degree between the at least one indication received and the set of recommendations related to the set of financial behaviors.

36. The computer readable storage medium of claim 35, wherein the computing the financial score includes computing the financial score according to the correlation degree.

37. A system, comprising:
means for generating a set of recommendations related to a set of financial behaviors;
means for determining a financial score based on at least one behavior that is determined to be related to the set of recommendations; and
means for adjusting the financial score based on different indications received related to the set of recommendations.

38. The system of claim 37, further comprising means for ascertaining a set of indications related to the set of financial behaviors.

39. The system of claim 38, wherein the means for determining the financial scores based on a set of indications of the at least one behavior received from a digital wallet or bank account aggregator and a correlation degree of the set of indications and the set of recommendations.
